(19) United States
(12) Patent Application Publication
(10) Pub. No.: US 2026/0037327 A1
(43) Pub. Date: Feb. 5, 2026

(54) REAL-TIME MIGRATION FOR STATELESS PODS

(71) Applicant: Kyndryl, Inc., New York, NY (US)

(72) Inventors: K Suryanarayana Rao, Bangalore (IN); Anil Kumar Reddy Edara, Ragareddy (IN); Gopalakrishnan Balasubramanian, Bangalore (IN); Badhrinath V, Bengaluru (IN)

(21) Appl. No.: 18/794,046

(22) Filed: Aug. 5, 2024

(51) Int. Cl. G06F 9/50

(52) U.S. Cl. CPC G06F 9/505

(57) ABSTRACT

A computer implemented system including multiple nodes within a container orchestration system. The container orchestration system defines sets of nodes as containers. A utilization monitoring module is configured to monitor at least one utilization metric of the sets of nodes. A migration controller is configured to trigger a migration of at least one pod from a first set of nodes to a second set of nodes based at least in part on the at least one utilization metric. A migration engine is configured to implement the migration of the at least one pod. A container orchestration system controller includes instructions for operating the utilization monitoring module, the migration controller, and the migration engine.

### BACKGROUND

The present invention relates to container orchestration systems for cloud computing, and more specifically, to a migration system for migrating stateless pods between nodes of a container orchestration system and thereby achieving load balancing.

As more computing services move toward cloud-native landscapes and computer systems that require cloud computing, the workload of those computer services is increasingly managed using containerization on a cloud computing network.

### SUMMARY

Embodiments of the present invention are directed to a computer implemented system including multiple nodes within a container orchestration system. The container orchestration system defines sets of nodes as containers. A utilization monitoring module is configured to monitor at least one utilization metric of the sets of nodes. A migration controller is configured to trigger a migration of at least one pod from a first set of nodes to a second set of nodes based at least in part on the at least one utilization metric. A migration engine is configured to implement the migration of the at least one pod. A container orchestration system controller includes instructions for operating the utilization monitoring module, the migration controller, and the migration engine.

Further embodiments of the present invention include non-transitory computer readable mediums storing instructions for implementing the computer implemented system and a cloud computing system configured according to the computer implemented system.

### BRIEF DESCRIPTION OF THE DRAWINGS

FIG. 1 depicts a block diagram of an example computer system for use in conjunction with one or more embodiments of the present invention;

FIG. 2 depicts a cloud computing environment according to one or more embodiments of the present invention;

FIG. 3 depicts abstraction model layers according to one or more embodiments of the present invention;

FIG. 4 depicts a process for migrating stateless pods in a cloud computing environment according to one example;

FIG. 5 schematically illustrates a process for initializing a new pod on an optimal working node within a cloud computing environment according to one example; and

FIG. 6 illustrates a workflow diagram for implementing the process of FIG. 4

### DETAILED DESCRIPTION

One or more embodiments are configured and arranged to provide container orchestration systems for cloud computing and a migration system for migrating stateless pods between nodes of a container orchestration system and thereby achieving load balancing.

As noted herein, computing services are moving toward cloud-native landscapes and computer systems that require cloud computing, such that the workload of those computer services is increasingly managed using containerization on a cloud computing network. One challenge faced with this configuration is the dynamic nature of a workload. With the number of pods running across a cluster of containers being in the tens of thousands, specifying accurate resource requests for containers becomes a virtually impossible task due to the fluctuating nature of application demands. This can lead to suboptimal resource utilization, where pods continue to run on a container to which they are initially assigned, even as conditions and available resources of the cluster change. When pods continue to run on the initially assigned container despite changes in conditions, performance bottlenecks, extreme slowdowns, and out of memory conditions on the container can result.

It is desirable to provide a system for migrating stateless pods between containers in real time and responsive to one or more usage metrics of the container.

In some cloud computing systems, once a task has been assigned to a node the assignment is locked in at that node until the task is completed. In such systems, the cloud computing environment monitors node usage metrics and attempts to evenly distribute load across the nodes by estimating an expected amount of resources required to implement the task and assigning the task to nodes with available capacity. However, as the distribution is based on estimated amounts of resources, it is possible for the distribution to be uneven. An uneven distribution can lead to suboptimal performance and resource wastage, particularly when the tasks involve or utilize stateless pods. A stateless pod is a pod that does not maintain persistent storage and/or session data. Stateless pods handle requests independently without relying on previous interactions and enable easier scaling and recovery.

The computer platform utilized to control the distribution of tasks to nodes is referred to as the container orchestration platform. One example container orchestration platform that could be used is a Kubernetes Cluster. The particular implementation of the container orchestration platforms disclosed herein can be varied for utilization with any corresponding container orchestration platform and is not limited to Kubernetes Clusters.

As used herein, container refers to a lightweight, standalone, executable package that includes everything needed to run a piece of software. This includes the code, runtime, system tools, libraries, and settings. Containers are isolated from each other and the host system. Containers ensure consistent runtime environments across different development, testing, and production environments.

As used herein, a pod refers to the smallest deployable unit in the container orchestration platform. A pod represents a single instance of a running process in a cluster. A pod can contain one or more containers that share storage, network, and a specification for how to run the containers. Pods are designed to support multiple cooperating processes that form a cohesive unit of service.

As used herein, a container orchestration platform is a automates the deployment, management, scaling, and networking of containers. A container orchestration platform ensures efficient resource utilization, high availability and scalability of containerized applications.

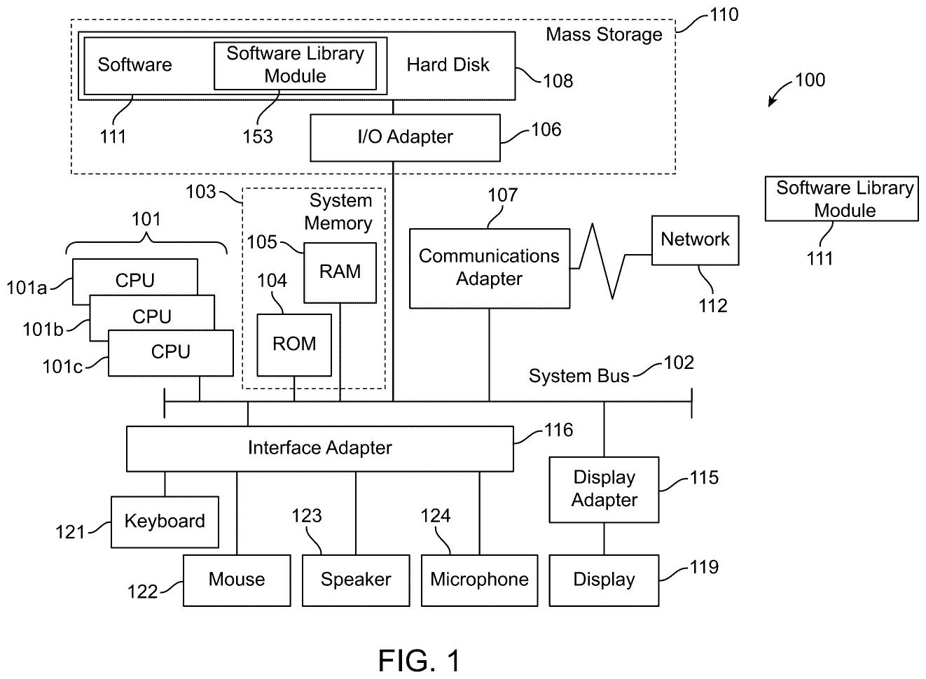

Turning now to FIG. 1, a computer system 100 is generally shown in accordance with one or more embodiments of the invention. The computer system 100 can be an electronic, computer framework comprising and/or employing any number and combination of computing devices and networks utilizing various communication technologies, as described herein. The computer system 100 can be easily scalable, extensible, and modular, with the ability to change to different services or reconfigure some features independently of others. The computer system 100 may be, for example, a server, desktop computer, laptop computer, tablet computer, or smartphone. In some examples, computer system 100 may be a cloud computing node. Computer system 100 may be described in the general context of computer system executable instructions, such as program modules, being executed by a computer system. Generally, program modules may include routines, programs, objects, components, logic, data structures, and so on that perform particular tasks or implement particular abstract data types. Computer system 100 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, the computer system 100 has one or more central processing units (CPU(s)) 101a, 101b, 101c, etc., (collectively or generically referred to as processor(s) 101). The processors 101 may include one or more processors which can be a single-core processor, multi-core processor, computing cluster, or any number of other configurations. The processors 101, also referred to as processing circuits, are coupled via a system bus 102 to a system memory 103 and various other components. The system memory 103 can include a read only memory (ROM) 104 and a random access memory (RAM) 105. The ROM 104 is coupled to the system bus 102 and may include a basic input/output system (BIOS) or its successors like Unified Extensible Firmware Interface (UEFI), which controls certain basic functions of the computer system 100. The RAM is read-write memory coupled to the system bus 102 for use by the processors 101. The system memory 103 provides temporary memory space for operations of said instructions during operation. The system memory 103 can include random access memory (RAM), read only memory, flash memory, or any other suitable memory systems.

The computer system 100 comprises an input/output (I/O) adapter 106 and a communications adapter 107 coupled to the system bus 102. The I/O adapter 106 may be a small computer system interface (SCSI) adapter that communicates with a hard disk 108 and/or any other similar component. The I/O adapter 106 and the hard disk 108 are collectively referred to herein as a mass storage 110.

Software 111 for execution on the computer system 100 may be stored in the mass storage 110 and may include a software library module 153. The mass storage 110 is an example of a tangible storage medium readable by the processors 101, where the software 111 is stored as instructions for execution by the processors 101 to cause the computer system 100 to operate, such as is described herein below with respect to the various Figures. Examples of computer program product and the execution of such instruction is discussed herein in more detail. The communications adapter 107 interconnects the system bus 102 with a network 112, which may be an outside network, enabling the computer system 100 to communicate with other such systems. In one embodiment, a portion of the system memory 103 and the mass storage 110 collectively store an operating system, which may be any appropriate operating system to coordinate the functions of the various components shown in FIG. 1.

Additional input/output devices are shown as connected to the system bus 102 via a display adapter 115 and an interface adapter 116. In one embodiment, the adapters 106, 107, 115, and 116 may be connected to one or more I/O buses that are connected to the system bus 102 via an intermediate bus bridge (not shown). A display 119 (e.g., a screen or a display monitor) is connected to the system bus 102 by the display adapter 115, which may include a graphics controller to improve the performance of graphics intensive applications and a video controller. A keyboard 121, a mouse 122, a speaker 123, a microphone 124, etc., can be interconnected to the system bus 102 via the interface adapter 116, which may include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI) and the Peripheral Component Interconnect Express (PCIe). Thus, as configured in FIG. 1, the computer system 100 includes processing capability in the form of one or more processors 101, storage capability including the system memory 103 and the mass storage 110, input means such as the keyboard 121, the mouse 122, and the microphone 124, and output capability including the speaker 123 and the display 119.

In some embodiments, the communications adapter 107 can transmit data using any suitable interface or protocol, such as the internet small computer system interface, among others. The network 112 may be a cellular network, a radio network, a wide area network (WAN), a local area network (LAN), or the Internet, among others. An external computing device may connect to the computer system 100 through the network 112. In some examples, an external computing device may be an external webserver or a cloud computing node.

It is to be understood that the block diagram of FIG. 1 is not intended to indicate that the computer system 100 is to include all of the components shown in FIG. 1. Rather, the computer system 100 can include any appropriate fewer or additional components not illustrated in FIG. 1 (e.g., additional memory components, embedded controllers, modules, additional network interfaces, etc.). Further, the embodiments described herein with respect to computer system 100 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

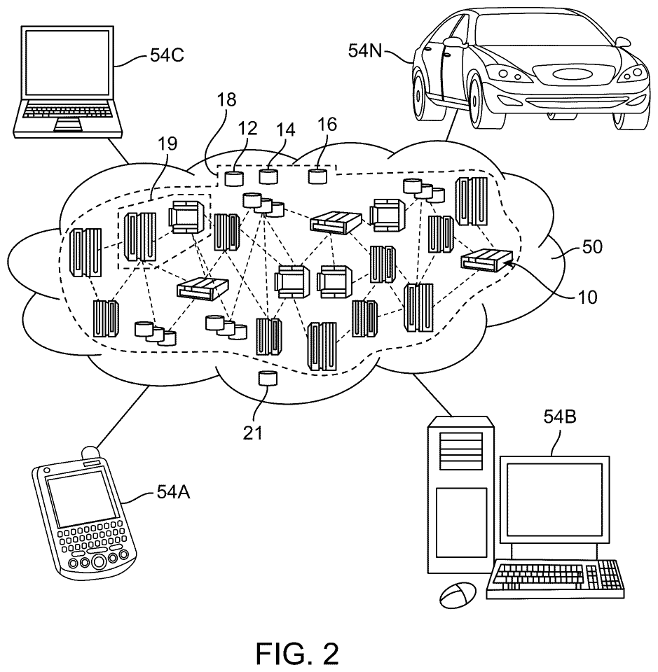

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described herein above, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 13 are intended to be illustrative only and that computing nodes 10 and cloud computing environment 50 can communicate with any type of computerized device over any type of network and/or network addressable connection (e.g., using a web browser).

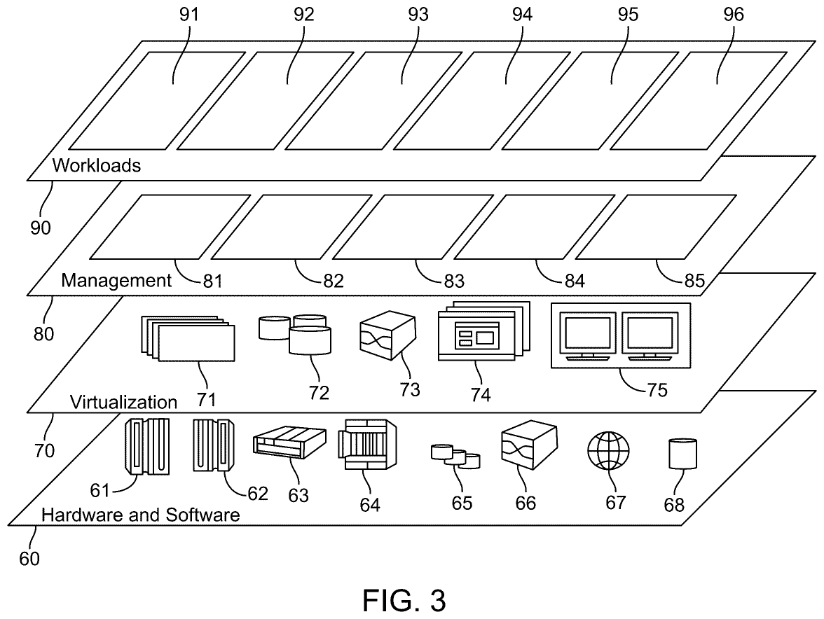

Referring now to FIG. 3, a set of functional abstraction layers provided by cloud computing environment 50 (depicted in FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and workloads and functions 96. The workloads and functions 96 include instructions for implementing or controlling portions of a container orchestration system within the cloud computing environment 50. In particular, the container orchestration system includes real time stateless pod migration.

Various embodiments of the present invention are described herein with reference to the related drawings. Alternative embodiments can be devised without departing from the scope of this invention. Although various connections and positional relationships (e.g., over, below, adjacent, etc.) are set forth between elements in the following description and in the drawings, persons skilled in the art will recognize that many of the positional relationships described herein are orientation-independent when the described functionality is maintained even though the orientation is changed. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. As an example of an indirect positional relationship, references in the present description to forming layer “A” over layer “B” include situations in which one or more intermediate layers (e.g., layer “C”) is between layer “A” and layer “B” as long as the relevant characteristics and functionalities of layer “A” and layer “B” are not substantially changed by the intermediate layer(s).

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The cloud computing environment 50 of FIGS. 2 and 3 addresses this inefficiency by implementing a real-time migration system for stateless pods within the container orchestration platform. The cloud computing environment 50 continuously monitors node 10 utilization metrics, such as CPU (central processing unit) usage and memory usage. Based on the monitored metrics, the cloud computing environment 50 migrates stateless pods (tasks) between nodes, with the migration balancing resource allocation based on actual usage of the node 10 resources instead of expected demand of the stateless pods. In this way, the overall efficiency of the nodes 10 is increased.

In order to implement the migration, three components are incorporated into the cloud computing environment 50 as part of a container orchestrating system 18. The container orchestrating system 18 include a utilization monitoring module 12, a migration controller 14, and a migration engine 16, which may include and/or be executed on one or more processors 101. The three components are focused on migrating stateless pods. By focusing the task migration on stateless pods, the container orchestration system 18 achieves efficient resource utilization and load balancing without requiring additional considerations related to data persistence or session affinity to be factored into the migration decisions. The example container orchestration system 18 enables dynamic pod migrations to adapt to changing workload demands and optimize resource allocation within the container orchestration system, benefiting both stateless and stateful applications alike.

The utilization monitoring module 12 collects and analyzes node 10 utilization metrics from clusters of nodes 10 (clusters 19) within the container orchestration platform 18. During operation the container orchestration platform 18 provides metrics application programing interfaces (APIs) that allow users to collect and monitor cluster-level metrics, including node 10 resource utilization metrics. The implementation of the utilization monitoring module 12 allows for the monitoring to be tailored to the real-time migration system implemented by the migration controller 14 thereby preventing collection and analysis of unnecessary operational metrics.

The migration controller 14 monitors utilization data and triggers stateless pod migrations based on predefined policies using a controller 21. The controller 21 is implemented as a control loop that monitors a state of the cluster 19 and makes changes to ensure that a desired state of each cluster 19 is maintained. The specialized migration controller 14 provides for the orchestration of pod migrations between nodes 10 and can be executed on one or more processors 101.

The migration engine 16 orchestrates pod migrations by interacting with an API server of the container orchestration platform. The implementation of a specialized migration engine facilitates isolating each task and transferring the task to a new node 10.

Determining whether a pod is stateless or stateful is typically based on the characteristics of the application running within the pod rather than inherent properties of the pod itself. The statefulness of the pod can be inferred using one or more inference methods including review of the configuration metadata, inspecting a pod definition, using application profiling, and/or via user input. The container orchestration system API allows users to attach metadata to pods, including annotations or labels that indicate whether the application within the pod is stateless or stateful. This metadata can be examined to assist in making decisions about pod migration.

In another example, the migration system can inspect the configuration of one or more pods to determine if the pods are stateful or stateless. For example, pods that mount persistent volumes or manage session state internally may be classified as stateful, while those that rely solely on external services for data storage may be classified as stateless.

In another example, the migration system can analyze the behavior and characteristics of an application running within the pod to infer the statefulness of the pod. For example, applications that perform write operations to local storage or maintain session state may be classified as stateful, while those that handle transient requests without storing data locally may be classified as stateless.

In another example, a user deploying a pod within the container orchestration system 18 is able to explicitly specify whether the application(s) within the pod are stateful or stateless when defining a pod configuration. These user-provided indications can then be respected when making decisions about pod migration.

The container orchestration system 18 utilized in the cloud computing environment 50 of FIG. 2 incorporates a combination of the above methodologies.

In some examples, the particular method by which the metrics are analyzed for identifying when a pod should be migrated to a new container can be an automated threshold-based migration and/or a predictive analytics based migration.

In an automated threshold based migration, the migration controller 14 is configured to monitor node utilization metrics and includes defined threshold values of each metric. When the metric violates the threshold, a migration is triggered and the migration controller 14 migrates the pod to a less utilized node. In this example, the pods are selected for migration based on resource requirements and cluster topology, ensuring an efficient resource allocation.

In a predictive analytics-based migration, machine learning algorithms are used to analyze historical utilization data and, based on the analysis, predict future resource demands. The machine learning algorithm develops a predictive model to forecast node 10 utilization trends and identify potential hotspots and/or resource bottlenecks. During operation, pods are proactively migrated from nodes 10 predicted to experience high utilization in the near future, thereby preventing performance degradation.

In some examples, the predictive analytics and the automated threshold-based migration are utilized in conjunction with each other. In such examples, the predictive analytics are used as a primary source of migration, and the threshold-based migration operates as a backup in the event that the prediction is inaccurate.

With continued reference to FIGS. 1-3, FIG. 4 illustrates an example process 400 for migrating a pod once the pod has been determined to be a stateless pod and when the nodes 10 in the cluster 19 containing the pod are, or are expected to be, overtaxed by the pods assigned to the cluster 19. The process 400 is performed for each pod in the container.

Initially the process 400 collects relevant ephemeral data regarding the state of the pod in a state collection step 410. The state collection step identifies relevant state data of the pod by determining any ephemeral data regarding the states which should be preserved. In some examples, the ephemeral data that should be preserved is identified in a custom metadata file associated with the pod, and the real-time migration system consults the custom metadata file during the state collection step 410. The ephemeral data elements include any data elements that are transient and yet vital for the operation of the pod. This can include in-memory data, temporary files, and environment configurations.

The full state is captured, including the ephemeral state data, using a snapshot mechanism that captures the identified state elements within the pod and includes creating a consistent snapshot of the pod's memory, variables, and runtime environment without interrupting the operation of the pod.

The collected states are serialized using custom serialization libraries for the pod in a serialized in-memory step 420, and the serialized states are configured to be applied to a new pod in the cluster 19 to which the pod is being migrated. Serialization includes converting the captured state(s) into a serialized format that can be efficiently transferred over the network. By way of example, serialization can include encoding the state into a structured format, such as JSON or binary thereby ensuring that the state maintains consistency and integrity during transfer. In some examples, configuring the serialized states includes converting state data from a native data format to a transferable data format. In addition, the environment variables (e.g. the variables of the container extrinsic to the pod but affecting the pod states) are captured and stored. In some examples this includes capturing and storing a dynamic configuration of the container.

The serialized data, including the environment data and the in-memory data, is stored in a persistent volume claim memory (PVC memory) or across the network. Once the serialized data has been stored, the process 400 transfers the current values of each state to the migration engine 16 in a state transfer step 430. In one example, PVC memory is utilized as the preferred serialized data storage, with storage distributed across a network only being utilized when PVC memory is unavailable.

After serializing and storing the data, the container orchestration system 18 captures dynamic state data using memory state monitoring and advanced filesystem watchers according to known processes, and the data is securely transferred with encryption using a node daemon to a new pod.

When the container orchestration system 18 has serialized and stored the data the process 400 initializes a new pod on the new node to which the data will be transferred in a pod initialization on new node at step 440.

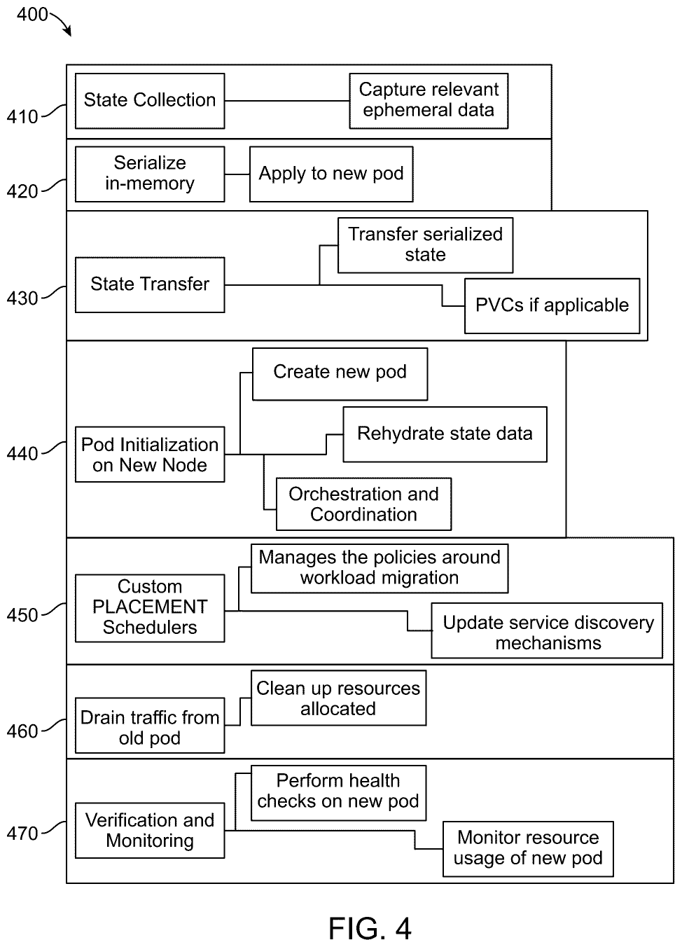

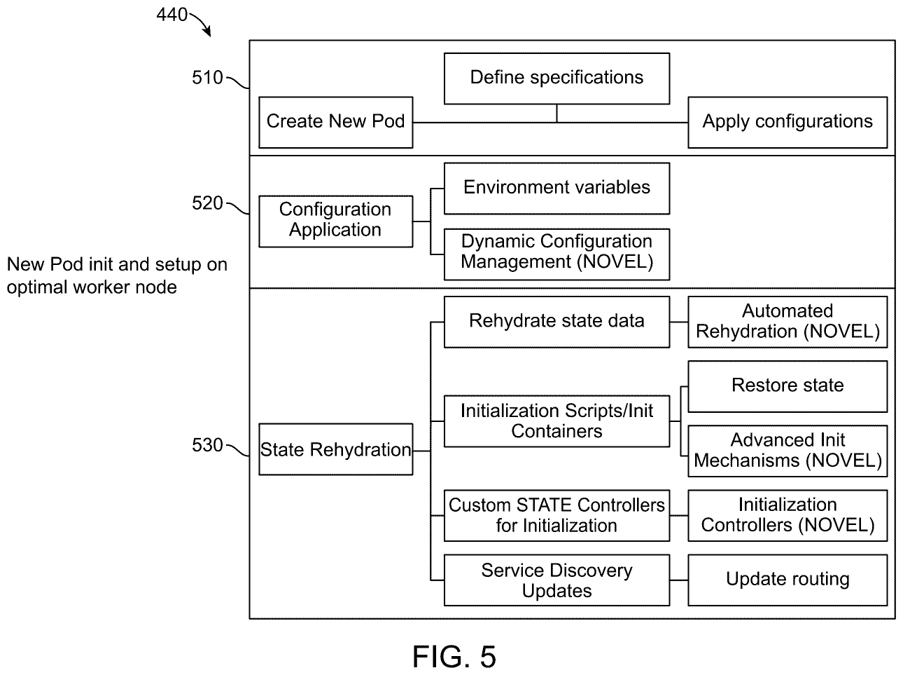

With continued reference to FIG. 4, FIG. 5 illustrates a more detailed process for the pod creation and initialization at step 440.

Initially the container orchestration system 18 creates the new pod on the new node 10 by identifying the specifications and configurations of the pod being transferred and applying the specifications and configurations of the pod being transferred to the new pod in a create new pod step 510.

Once the new pod is created, the new pod is configured with the environment variables of the pod being transferred using a dynamic configuration management module in a configuration application step 520. As used herein, a dynamic configuration management module is a system component that automatically adjusts the settings and parameters of the container orchestration platform based on real-time resource utilization metrics. This module ensures optimal performance by continuously monitoring node utilization and dynamically migrating stateless pods between nodes to balance resource allocation. It operates by collecting and analyzing data from the cluster, using predefined policies and thresholds to trigger migrations and employing predictive analytics to forecast future resource demands and thus enhances overall cluster efficiency and application performance.

Once the pod is created and configured, the states of the old pod are recreated at the new pod in a state rehydration step 530. In the state rehydration step 530, the state data is rehydrated using an automated rehydration process including initialization scripts that initialize the container, restore the states of the container, and provide advance initialization mechanisms. In some examples, the state rehydration can include custom state controllers for the initialization, initialization controllers, service discovery updaters and update routing systems.

Referring again to FIG. 4, once the new pod has been created and initialized, the process 400 uses a custom placement scheduler to set policies and workload migration rules for scheduling the migration from the old pod to the new pod, as well as to update service discovery mechanisms in a custom placement scheduler step 450. The custom placement scheduler provides control flexibility and intelligence to manage the real-time pod migration effectively and to optimize resource utilization.

Once the migration is scheduled, the process 400 drains traffic from the old pod and cleans up any resources allocated to the old pod in a drain traffic to old pod step 460. Once cleaned up, traffic for the tasks assigned to the transferred pod are routed to the new pod only, and the operation proceeds with the new pod.

Lastly, the container orchestration module verifies and monitors the operations of the new pod in a verification and monitoring step 470. The verification and monitoring includes performing health checks on the new pod and monitoring the resource usage of the new pod in order to ensure that the new pod is not overallocated.

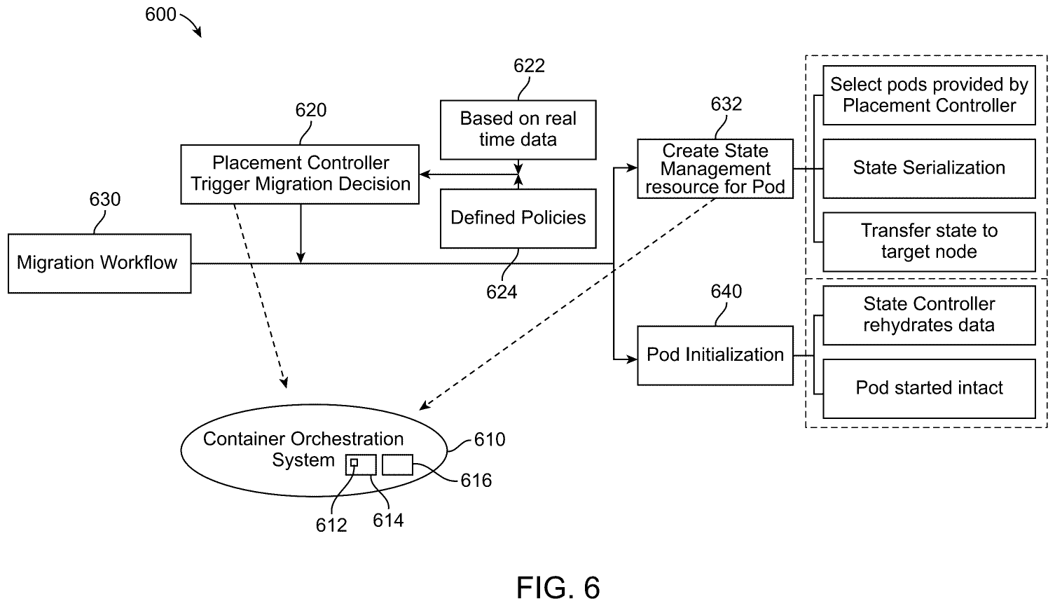

With continued reference to FIGS. 1-5, FIG. 6 illustrates a workflow diagram 600 for implementing the process 400 of FIGS. 4 and 5 for a given pod 612 within a container orchestration system 610. A placement controller 620 monitors the real time data 622 of the pod 612 and compares the real time data 622 to defined polices 624. When the policies 624 and the real time data 622 indicate that the pod 612 should be migrated to a new container (e.g. from a first node 614 to a second node 616), a migration workflow 630 is triggered. The migration workflow 630 creates the state management resources 632 including pod selections 634 and state serialization 636 and then transfers the serialized state to the new node 616. The migration workflow 630 also handles the pod initialization 640, including rehydrating the state controller data 642 and ensuring that the pod 612 is started on the new node 616 intact.

With continued reference to FIGS. 1-6, the process 400 provides for a state extraction and serialization methodology for transferring a pod 612 from one node 614 to another node 616. The process 400 focuses on the migration of stateless pods, which traditionally do not maintain a persistent state that needs to be transferred. The process 400 advantageously addresses the specifics of migrating stateless pods by identifying and transferring ephemeral state elements that are not typically considered by traditional stateful migration tools. This approach minimizes application downtime by rapidly capturing, transferring, and reconstructing the pod's operational state, offering a smoother transition with minimal impact on the user experience. Furthermore, this approach allows for leveraging of real-time data analytics to adaptively respond to changing cluster conditions and application demands, unlike the more static nature of existing tools.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted, or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable program instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer implemented system comprising:
a plurality of nodes within a container orchestration system, the container orchestration system defining sets of nodes within the plurality of nodes, wherein the sets of nodes are containers;
a utilization monitoring module configured to monitor at least one utilization metric of the sets of nodes in the plurality of nodes;
a migration controller configured to trigger a migration of at least one pod from a first set of nodes in the plurality of nodes to a second set of nodes in the plurality of nodes based at least in part on the at least one utilization metric;
a migration engine configured to implement the migration of the at least one pod; and
a container orchestration system controller, wherein the migration controller includes instructions for operating the utilization monitoring module, the migration controller, and the migration engine.

2. The computer implemented system of claim 1, wherein the at least one pod is a stateless pod.

3. The computer implemented system of claim 1, wherein migrating the at least one pod comprises:
collecting a set of states of a first pod of the at least one pod operating on the first set of nodes;
serializing the collected set of states;
transferring the serialized collected set of states to the second set of nodes in the plurality of nodes; and
initializing a second pod as a new pod on the second set of nodes, the new pod including the serialized collected set of states.

4. The computer implemented system of claim 3, further comprising draining traffic to the first pod subsequent to initializing the second pod.

5. The computer implemented system of claim 3, wherein migrating the at least one pod is performed in response to the utilization monitoring module determining the first set of nodes is overtaxed, the determination being based at least in part on one of an automated threshold or a predictive analytic.

6. The computer implemented system of claim 5, wherein the predictive analytic comprises a predictive model configured to forecast node utilization trends and identify potential overtaxation, and wherein the predictive model is machine learning derived.

7. The computer implemented system of claim 5, wherein the automated threshold includes at least one utilization metric threshold and the migration occurs when the at least one utilization metric threshold is violated.

8. The computer implemented system of claim 5, wherein the determination is based on a hybrid of the automated threshold and the predictive analytic.

9. A computer readable medium storing instructions for implementing a container orchestration system, the container orchestration system performing operations comprising:
configuring a plurality of nodes defined in sets of nodes, wherein the sets of nodes are containers;
monitoring at least one utilization metric of the sets of nodes in the plurality of nodes using a utilization monitoring module;
migrating of at least one pod from a first set of nodes in the plurality of nodes to a second set of nodes in the plurality of nodes based at least in part on the at least one utilization metric using a migration controller; and
implementing the migration of the at least one pod using a migration engine.

10. The computer readable medium system of claim 9, wherein the at least one pod is a stateless pod.

11. The computer readable medium of claim 9, wherein migrating the at least one pod comprises:
collecting a set of states of a first pod of the at least one pod operating on the first set of nodes;
serializing the collected set of states;
transferring the serialized collected set of states to the second set of nodes in the plurality of nodes; and
initializing a second pod as a new pod on the second set of nodes, the new pod including the serialized collected set of states.

12. The computer readable medium of claim 11, the operations further comprising draining traffic to the first pod subsequent to initializing the second pod.

13. The computer readable medium of claim 11, wherein migrating the at least one pod is performed in response to the utilization monitoring module determining the first set of nodes is overtaxed, the determination being based at least in part on one of an automated threshold or a predictive analytic.

14. The computer readable medium of claim 13, wherein the predictive analytic comprises a predictive model configured to forecast node utilization trends and identify potential overtaxation, and wherein the predictive model is machine learning derived.

15. The computer readable medium of claim 13, wherein the automated threshold includes at least one utilization metric threshold and the migration occurs when the at least one utilization metric threshold is violated.

16. The computer readable medium of claim 13, wherein the determination is based on a hybrid of the automated threshold and the predictive analytic.

17. A cloud computing system comprising:
a plurality of nodes; and
a container orchestration system organizing the plurality of nodes into containers, the container orchestration system including a utilization monitoring module configured to monitor at least one utilization metric of sets of nodes in the plurality of nodes, a migration controller configured to trigger a migration of at least one pod from a first set of nodes in the plurality of nodes to a second set of nodes in the plurality of nodes based at least in part on the at least one utilization metric, a migration engine configured to implement the migration of the at least one pod, and a container orchestration system controller.

18. The cloud computing system of claim 17, wherein the migration of the at least one pod comprises:
collecting a set of states of a first pod of the at least one pod operating on the first set of nodes;
serializing the collected set of states;
transferring the serialized collected set of states to the second set of nodes in the plurality of nodes; and
initializing a second pod as a new pod on the second set of nodes, the new pod including the serialized collected set of states.

19. The cloud computing system of claim 18, wherein the migration of the at least one pod further comprises draining traffic to the first pod subsequent to initializing the second pod.

20. The cloud computing system of claim 18, wherein the migration of the at least one pod is performed in response to the utilization monitoring module determining the first set of nodes is overtaxed, the determination being based at least in part on one of an automated threshold and a predictive analytic.
